(19) United States
(12) Patent Application Publication
(10) Pub. No.: US 2014/0266953 A1
(43) Pub. Date: Sep. 18, 2014

(54) ANTENNA HAVING SPLIT DIRECTORS AND ANTENNA ARRAY COMPRISING SAME

(71) Applicant: Chih-Chuan YEN, San Marcos, CA (US)

(72) Inventor: Chih-Chuan YEN, San Marcos, CA (US)

(73) Assignee: SIERRA WIRELESS, INC., Richmond (CA)

(21) Appl. No.: 13/836,558

(22) Filed: Mar. 15, 2013

(51) Int. Cl. H01Q 9/20; H01Q 5/00

(52) U.S. Cl. CPC H01Q 9/20; H01Q 5/0065
USPC 343/818

(57) ABSTRACT

An antenna is provided comprising a pair of driven elements and a pair of passive elements. The driven elements are disposed on opposite sides of a reference plane, and the passive elements are also disposed on opposite sides of the reference plane. One or both passive elements may be provided in a different plane than the driven elements. By varying placement of the passive elements the antenna radiation pattern can be altered. An antenna array is also provided, comprising two or more oppositely directed directional antennas at least one of which is as described above. The passive elements of the antennas can be adjusted for a desired coverage pattern of the array, such as an azimuthal omnidirectional pattern, for example through simulation. The antenna or array may be embodied on a printed circuit board.

### FIELD OF THE TECHNOLOGY

The present technology pertains in general to antennas and in particular to antennas and antenna arrays having both active and passive elements.

### BACKGROUND

Antennas are widely used in the field of communications. Various designs, particularly for portable electronic devices, involve antennas provided as circuit traces on a printed circuit board (PCB).

A well-known antenna is the Yagi-Uda antenna, which includes a driven dipole and a series of reflectors and directors arranged in parallel with the dipole. A reflector is a single body which is longer than the dipole, while the directors are single bodies which are shorter than the dipole. Reflectors and directors and dipoles are typically symmetric about a common axis. The Yagi-Uda antenna is typically used to provide a directional radio signal. Specifically, the Yagi-Uda antenna can be made to have higher gain in one direction relative to a standard dipole antenna or isotropic radiator, thus exhibiting a relatively high directivity, as measured in dBi. Versions of the Yagi-Uda antenna can be provided as circuit traces on a PCB, as illustrated in FIG. 1, which depicts a Yagi-Uda antenna comprising a driven dipole element 110, a reflector 120 and a set of directors 130. However, the characteristic radiation pattern provided by the classic Yagi-Uda antenna and its variants may not be completely suitable for all applications.

For example, although antenna directivity is desirable for achieving high antenna gain in a given direction, it is often desirable to obtain a more even distribution of relatively high antenna gain, for example within a given plane such as the azimuthal or horizontal plane. One solution is to use an array of directional antennas, each antenna in the array being oriented differently so that the overall combined radiation pattern is roughly evenly distributed over the directions of interest. However, with standard antenna designs, such as the Yagi-Uda antenna, the desired combined pattern can be difficult to obtain with suitable precision. In addition, packing more than a few antennas into a small space may be problematic both spatially and due to potential mutual coupling and interference problems.

Therefore there is a need for a means by which antenna radiation patterns can be effectively provided yet also adjusted or fine-tuned to suit a particular application, such as use in an antenna array, such a means not being subject to one or more limitations in the prior art.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present technology is to provide an antenna having split directors and an antenna array comprising same. In accordance with an aspect of the present invention, there is provided an antenna comprising: a first driven element disposed on a first side of a reference plane and a second driven element spaced apart from the first driven element and disposed on a second side of the reference plane opposite the first side; a first passive element disposed within near-field distance of the first driven element, the first passive element disposed on the first side of the reference plane; and a second passive element disposed within near-field distance of the second driven element, the second passive element spaced apart from the first passive element and disposed on the second side of the reference plane.

In accordance with an aspect of the present invention, there is provided an antenna array comprising two or more antennas, at least one of said two or more antennas comprising: a first driven element disposed on a first side of a reference plane and a second driven element spaced apart from the first driven element and disposed on a second side of the reference plane opposite the first side; a first passive element disposed within near-field distance of the first driven element, the first passive element disposed on the first side of the reference plane; and a second passive element disposed within near-field distance of the second driven element, the second passive element spaced apart from the first passive element and disposed on the second side of the reference plane.

### BRIEF DESCRIPTION OF THE FIGURES

These and other features of the technology will become more apparent in the following detailed description in which reference is made to the appended drawings.

FIG. 1 illustrates a Yagi-Uda antenna in accordance with the prior art.

FIG. 2 illustrates an antenna provided in accordance with one embodiment of the technology.

FIG. 3 illustrates an antenna provided in accordance with another embodiment of the technology.

FIGS. 4a and 4b illustrate antenna arrays provided in accordance with embodiments of the technology.

FIGS. 5a and 5b illustrate front and back views of a printed circuit board comprising an antenna provided in accordance with an embodiment of the present technology.

FIGS. 5c and 5d illustrate front and back views of a printed circuit board comprising another antenna provided in accordance with an embodiment of the present technology.

FIG. 6 illustrates a radiation pattern of an antenna array comprising a pair of prior art Yagi-Uda antennas.

FIG. 7 illustrates a graph of antenna gain versus frequency for a pair of antennas in an antenna array, in accordance with an embodiment of the present technology.

FIG. 8 illustrates a radiation pattern of an antenna array comprising a pair of antennas in accordance with an embodiment of the present technology.

### DETAILED DESCRIPTION

### Definitions

The term “near-field” refers to that region of an electromagnetic field close to the source in the typical manner as would be understood by a worker skilled in the art. For example, the near-field may refer to the region in which the electric field is characterized mainly due to charge distributions of the field source, and the magnetic field is characterized mainly due to electric currents of the field source. This is in contrast to the far field, where the electric field is characterized mainly due to changes in the magnetic field, and the magnetic field is characterized mainly due to changes in the electric field. Additionally or alternatively, the near-field may refer to the region around an object wherein inductive coupling and/or capacitive coupling is appreciable. Additionally or alternatively, the near-field may be defined in terms of known metrics, such as the Fraunhofer distance. As used herein, the near-field region may include some or all of the so-called “transition zone.” It is noted that distance to which the near-field extends may be dependent on frequency of the time-varying electromagnetic field, among other factors.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

An aspect of the present invention provides an antenna comprising a driven portion and a set of passive elements disposed within near-field distance of the driven portion. The driven portion may be operatively coupled, at a feedpoint, to a transmission line, and via the transmission line the driven portion may be connected to radio electronics of a transmitter, receiver, or both. The driven portion comprises a first driven element and a second driven element, for example making up two spaced-apart halves of a dipole antenna. For ease of exposition, a reference plane is defined herein such that the first driven element is disposed on a first side of the reference plane and the second driven element is disposed on a second side of the plane opposite the first side. The reference plane may pass through a gap coinciding with a feedpoint of the dipole antenna, for example. Alternatively, the reference plane may pass through a driven antenna structure comprising one, two or more active elements, such that the plane passes substantially through or near a symmetry plane of the driven antenna structure. A first passive element is disposed on the first side of the reference plane, and a second passive element is disposed on the second side of the reference plane, the second passive element spaced apart from the first passive element. The reference plane does not necessarily correspond to any physical structure.

In various embodiments, the antenna may be regarded conceptually as a Yagi-Uda style antenna in which at least one of the directors is split into pieces, the pieces then being moved apart from each other in one or more directions. Referring to FIG. 2, an antenna driven portion comprising a first driven element 210 and a second driven element 215 is illustrated. The first and second driven elements form two halves of a dipole antenna, although other driven antenna structures are also possible. A reference plane 220 is shown passing through a center of the driven portion, between the first driven element 210 and the second driven element 215. The antenna further comprises a first passive element 230 and a second passive element 235, disposed on opposite sides of the reference plane 220, and separated by a gap 232. The active elements and the passive elements may extend away from the reference plane 220, for example in a direction orthogonal to the reference plane. It is noted that the passive elements are shorter than the driven elements, which results in the passive elements exhibiting capacitive reactance in conjunction with the driven elements. This is similar to the configuration of directors in a Yagi-Uda antenna, and for this reason the first and second passive elements may be referred to as sub-directors.

The antenna as illustrated in FIG. 2 exhibits a variety of regularities and symmetries, at least some of which are optional. The driven elements 210 and 215 and the passive elements 230 and 235 are all coplanar, lying within a second reference plane 240 which is orthogonal to the reference plane 220. In some embodiments, coplanarity allows for the elements to be provided as conductive features on a common surface of a printed circuit board. In addition, the driven elements 210 and 215 are collinear, i.e. lying along a common reference axis 250, and the passive elements 230 and 235 are also collinear, i.e. lying along a common reference axis 252, which in this case is parallel to the reference axis 250. In addition, a distance between the first passive element 230 and the first driven element 210 is about equal to a distance between the second passive element 235 and the second driven element 215. In addition, the driven elements and the passive elements are disposed symmetrically about the reference plane 220.

Features of the antenna illustrated in FIG. 2 may be adjusted in various ways while retaining the above regularities and symmetries, for example by adjusting the size and shape of the various elements, moving the passive elements closer to each other or further from each other, or closer to or further from the active elements. This may result in a corresponding adjustment to the antenna's radiation pattern.

Features of the antenna illustrated in FIG. 2 may also be adjusted in various ways which break one or more of the above regularities and symmetries. For example, one or more of the various driven or passive elements can be rotated in a symmetry-preserving or symmetry breaking way. Rotation may be within the second reference plane 240 or out of the second reference plane. As another example, collinearity of the passive elements may be broken, for example by translating one of the passive elements away from the reference axis 252, or by arranging the passive elements in a curved or curvilinearly staggered manner around the driven elements.

As yet another example, one or both of the passive elements may be disposed out of the second reference plane 240. For example one or both the first and second passive elements may be located in a third reference plane which is parallel to the second reference plane, or the first passive element may be located in the third reference plane while the second passive element may be located in a fourth reference plane parallel to but different from the third reference plane. In the case that one or both of the passive elements are translated out of the second reference plane, other symmetries and regularities may be preserved with respect to orthogonal projections or “shadows” of the passive elements back into the second reference plane. For example, orthogonal projections of the passive elements into the second reference plane may be collinear with each other (e.g. located along a common reference axis 252), symmetric about the reference plane, or the like.

FIG. 3 illustrates the above configuration in the form of an antenna comprising a first driven element 310 and a second driven element 315. A reference plane 320 is shown passing between the first driven element 310 and the second driven element 315. The antenna further comprises a first passive element 330 and a second passive element 335, disposed on opposite sides of the reference plane 320. The first and second driven elements 310 and 315 are disposed within a second reference plane 340, which may be substantially orthogonal to the reference plane 320. The first passive element 330 is disposed within the second reference plane, while the second passive element 335 is disposed within a third reference plane 345 parallel to the second reference plane. An orthogonal projection 337 of the second passive element 335 onto the second reference plane is also illustrated. For example, the second reference plane may coincide with one layer of a PCB, such as a top layer, upon which the driven elements and the first passive element are provided as conductive features, while the third reference plane may coincide with another layer of the PCB, such as a bottom layer, upon which the second passive element is provided as a conductive feature.

To compensate for the intervening dielectric material and increased distance from the antenna driven portion, the location of a passive element which is located on a different PCB layer than the antenna driven portion may be adjusted, for example such that the electrical interaction of the out-of-plane passive element has substantially the same strength as the electrical interaction of a corresponding in-plane passive element.

In various embodiments, the plural passive elements operate as plural directing radiators through induced current caused by the driven elements. Current induction in passive elements placed within the near-field of driven antenna elements is a phenomenon which is understood within the art. For example, in a transmitting antenna, the electromagnetic field generated by the driven elements induces corresponding charge distributions and/or currents in the passive elements, which in turn generate corresponding electromagnetic fields of their own. The superposition of fields leads to an overall antenna radiation pattern that is influenced by both the active and passive elements. In a receiving antenna, a complementary situation is encountered.

In various embodiments, by using pairs of sub-directors and by adjusting placement of the sub-directors (for example by adjusting the separation distance between them, or by moving one or both of the sub-directors out of a second reference plane containing the driven elements, or a combination thereof, the overall antenna radiation pattern can be adjusted.

For example, by arranging a pair of passive elements (sub-directors) in a staggered fashion (e.g. spaced apart in the second reference plane), the radiation pattern of each passive element may be adjusted so that it is directional but pointing at a slightly slanted angle. For example, each sub-director may direct a beam of RF energy in a direction slightly off from an axis of symmetry between the two sub-directors and towards the sub-director. When the radiation patterns of the passive and active elements are combined, the resulting pattern can resemble that of a Yagi-Uda antenna, except that the beamwidth of the main lobe is expanded. This may improve (i.e. reduce) the peak-to-trough characteristics of the radiation pattern, relative to that of a Yagi-Uda antenna.

In some embodiments, the antenna may be a directional antenna having its highest gain in a first direction, typically corresponding to the center of a main lobe. The peak-to-trough ratio of the radiation pattern, evaluated over the half-plane centered on the antenna and containing the main lobe (i.e. +/−90 degrees from the first direction) may be lowered. For example, areas of relatively low gain in the radiation pattern over the half plane may be converted to areas of higher gain. This may lead toward an idealized semicircular shape for the radiation pattern in this half-plane, for example. When the radiation patterns of two oppositely facing antennas are combined, a more uniform circular radiation pattern may be achieved to lower peak-to-trough ratio in the combined coverage pattern.

In some embodiments, the antenna is configured to provide a radiation pattern having a planar cross section with a desired set of characteristics substantially as described below. In some embodiments, the planar cross section may correspond to an azimuthal plane of the antenna, or to a cross section lying in or parallel to a main plane in which the antenna elements are disposed, or both. For example, the cross section may substantially coincide with the surface of a PCB upon which the antenna is printed. The cross-section of the radiation pattern comprises a lobe which extends over at least 180 degrees. The lobe may be regarded as the cross section of a three-dimensional lobe. In some embodiments the lobe is a main lobe of the antenna radiation pattern. Alternatively, it is possible for the lobe to correspond to a side lobe. The lobe may comprise a null at each of its two endpoints within the plane but otherwise may be free of interior nulls. The lobe includes a planar sub-region of about 180 degrees or greater, falling within the planar cross section. The gain variation within the sub-region is substantially limited. The gain variation may be described as exhibiting a low peak-to-trough ratio over the sub-region. For example, in various embodiments, the gain variation is about 7 dB or less. In various embodiments, the dB measurement may be relative to an isotropic antenna, so that the gain variation is about 7 dBi or less. Thus, the antenna radiation pattern is such that, within a plane of interest, the gain varies by less than a predetermined amount over at least a 180 degree angle. Such a radiation pattern may be obtained by arranging the passive elements so as to substantially evenly disperse RF energy across an appropriately wide angle within the plane of interest.

The cross-sectional radiation pattern may be such that the gain is generally increasing toward the central direction of the lobe, as would be readily understood by a worker skilled in the art.

As an example, in some embodiments, if the antenna has a maximum gain of G dBi along a substantially central direction within the lobe and sub-region, the central direction falling within the plane of interest, then at directions which are perpendicular to this central direction and also falling with the plane of interest, the gain will be no less than about (G−7) dBi. Moreover, in all directions within the plane of interest and falling within 90 degrees left or right of the central direction (i.e. all directions within the sub-region), the gain will also be no less than about (G−7) dBi.

As another, more general example, in some embodiments, if the antenna has a maximum gain of G dBi along a first direction within the lobe and sub-region, the first direction not necessarily coinciding with the central direction, then in all directions within the sub-region, the gain will also be no less than about (G−7) dBi. Thus the maximum gain need not coincide with the central direction.

In various embodiments, the passive elements are disposed so as to substantially evenly disperse the RF energy over a wide lobe angle as described above. Separating a director-type passive element into pieces as described herein provides one method for achieving such dispersal.

Outside of the sub-region or associated lobe or both, the gain may drop precipitously or gradually, the gain may vary, and/or one or more lobes or nulls may be present.

In some embodiments, the sub-directors are made to be co-planar with the driven elements. In other embodiments, the sub-directors are staggered with respect to the second reference plane, which may coincide with the azimuthal plane in various embodiments. For sub-directors which are co-planar with the driven elements, the beamwidth may be affected primarily in a direction orthogonal to the second reference plane (e.g. a direction falling within the elevation plane). However, it has been observed that the beamwidth in the second reference plane (e.g. the azimuthal plane) can still be expanded as desired to lower the peak-to-trough ratio.

In various embodiments, the passive elements (sub-directors) are shorter than the driven element and can thus exhibit capacitive reactance. Furthermore, the induced current within the passive elements can experience phase reversal. The length of each passive element and the spacing there between can affect the degree of phase reversal. Together with an additional separation distance from the driven element (which also contributes to the phase delay), various degrees of superposition of forward energy and thus different antenna gains and radiation patterns can be achieved.

In some embodiments, phase reversal within passive elements corresponds to the appropriate passive elements re-radiating electromagnetic energy which is about 180 degrees out of phase from the electromagnetic energy radiated by the driven elements. Phase reversal may influence parameters such as the Array Factor, which is a known concept in the art of antenna theory and design. In some embodiments, the phase reversal may be combined with an antenna element separation distance of about one quarter of an operating RF wavelength, which may result in an end-fire array factor. Such an end-fire array factor may facilitate gain enhancement.

In some embodiments, the antenna comprises three, four or more passive elements. In some embodiments, a third passive element may be a reflector, for example placed on an opposite side of the driven elements from the first and second passive elements described above and being longer than the driven elements.

In some embodiments, a third passive element may be provided as standard Yagi-Uda style director located on the same side of the driven elements as the first and second passive elements described above and being shorter than the driven elements.

In some embodiments, a third and possibly a fourth passive element may be provided which are substantially collinear with the first and second passive elements.

In some embodiments, third and fourth passive elements may be provided on opposite sides of the reference plane. The third and fourth passive elements may be disposed on an opposite side of the first and second passive elements from the driven elements.

In various embodiments, the antenna elements are substantially planar, and may optionally be provided as patterns on one, two or more layers of a printed circuit board. In some embodiments, a planar or printed wire reflector may be provided along with the other passive elements such as sub-directors. In other embodiments, one or more antenna elements are three-dimensional. For example, a reflector may be a three-dimensional design, such as a parabolic reflector, corner reflector, or the like. Similarly, the driven portion of the antenna may be provided as a planar dipole or other two-dimensional or three-dimensional structure. Various driven antenna structures may be used as would be readily understood by a worker skilled in the art. Generally the appropriate arrangement of passive elements will depend in part on the configuration of the driven elements.

In various embodiments, the arrangement of antenna elements necessary for providing a desired overall antenna radiation pattern can be determined by simulation, for example using a commercially available full-wave EM simulator.

In various embodiments, additional passive elements may be provided for the antenna. The additional passive elements may be arranged in complementary pairs about the reference plane as with the first and second passive element, or they may be arranged as with more traditional Yagi-Uda style passive elements, such as reflectors and directors.

Another aspect of the present technology provides an antenna array comprising a plurality of antennas as described elsewhere herein. Each of the plurality of antennas comprises a driven portion for example comprising first and second driven elements. Each driven portion may be coupled to a separate source or driver, or plural driven portions may be coupled to a common source or driver, for example via a power combiner or splitter. In some embodiments, the power combiner or splitter may direct power to and/or from different antennas in a temporally multiplexed fashion, for example by switching between antennas at an appropriate frequency. In other embodiments, the power combiner or splitter may direct power to and/or from different antennas simultaneously. At least one of the plurality of antennas comprises at least two passive elements arranged on either side of a reference plane which passes between the first and second driven elements, and from which the driven elements and passive elements may extend substantially orthogonally. The antennas may be configured, for example via arrangement of its passive elements, to exhibit desired radiation patterns, such that the combined radiation patterns of the various antennas in the array corresponds to a further overall desired radiation pattern. For example, the overall desired radiation pattern may be one which exhibits a measure of uniformity in all directions within an azimuthal plane. Uniformity may be expressed via a peak-to-trough ratio, which expresses the ratio of the maximum gain of the antenna within a given plane (e.g. the azimuthal plane) to the minimum gain of the antenna within that given plane. In some embodiments, a peak-to-trough ratio of less than 7 dB (or 7 dBi) may be exhibited.

The radiation patterns of plural antennas may be combined in various senses and/or using various techniques. For example, in some embodiments, the plural antennas operate together as a phased array or beam forming array. In one embodiment, the plural antennas may operate together as if they were a single antenna with beam characteristics that can be changed electrically by adjusting the relative phase delays of their connections.

In a further embodiment, the antennas of a beam forming array are connected array to more than one phasing system connected to separate transmitters and/or receivers so that they can concurrently produce more than one beam. These beams may be orthogonal, or at least significantly separated from each other. Once different beams have been established these may then be used in a MIMO application.

In some embodiments, radiation patterns of plural antennas may be combined using a fixed array system via a power combiner and/or splitter. However, this may result in a loss of gain at the splitter (e.g. a 3 dB loss due to halving the signal), which may not be desirable. Alternatively, a switched scheme may be used in which power is switched to each antenna in an alternating manner, to implement a temporal multiplexing MIMO system.

In some embodiments, the antenna array may be used to implement a spatial multiplexing MIMO system, in which plural antennas are connected to multiple ports, and multiple data streams can be transmitted or received concurrently to increase data throughput.

In some embodiments, MIMO and/or antenna diversity is employed in which different antennas have separate uncorrelated beam patterns so that they receive signals that have taken different paths. This may involve different antennas being connected to different receivers and possibly different transmitters. Transmitter antennas in such systems are typically uncorrelated in terms of separation of the direction that they transmit in. In some embodiments, uncorrelation of a pair of antennas may be realized in that each antenna has a radiation pattern which faces in a different direction. For example, a first antenna may have relatively high gain in a first set of directions and relatively low gain in a second set of directions, while a second antenna may have relatively low gain in the first set of directions and relatively high gain in the second set of directions. In one embodiment, the first set of directions may correspond substantially with a first half of a circle while the second set of directions may correspond substantially with a second half of the circle which is complementary to the first half.

For example, each of a pair of antennas making up the antenna array may be configured as directional antennas having a wider beamwidth and improved peak-to-trough ratio by using separate sub-directors, when compared to a standard Yagi-Uda style antenna. The two antennas may be directed in opposite directions so that their combined radiation pattern in a given plane is substantially omni-directional. It is noted that, in this configuration, the peak-to-trough ratio of the resulting antenna array is improved relative to a similar antenna array comprising a pair of oppositely directed Yagi-Uda antennas. In some embodiments, at least +2 dB improvement (i.e. reduction) in the azimuthal peak-to-trough ratio can be obtained.

In some embodiments, the two oppositely directed antennas may be used in a MIMO system, each antenna being operatively coupled to a separate transmitter and/or to a separate receiver. The combined radiation patterns of the two antennas may be configured to functionally provide 360 degrees of communication coverage without directly connecting the antennas.

FIG. 4a illustrates an antenna array provided in accordance with embodiments of the present technology. The antenna array comprises a first antenna and a second antenna. The first antenna comprises a pair of driven elements 410a, 415a and a pair of passive elements 430a, 435a. The active elements are divided from each other by a plane 420a, and the passive elements are divided from each other by the same plane. The second antenna comprises a pair of driven elements 410b, 415b and a pair of passive elements 430b, 435b. The active elements are divided from each other by a plane 420b, and the passive elements are divided from each other by the same plane. An optional reflector 440 operates as a further passive element of both the first antenna and the second antenna. In some embodiments, if a shield or reflector 440 is not used then the antennas may be spaced apart to mitigate antenna coupling.

As illustrated, the elements of both antennas lie within a common plane. However, different antenna elements may lie within different planes. In some embodiments, different antennas may lie completely within different planes or sets of planes. In some embodiments, antenna elements of different antennas may lie within one or more common planes. In some embodiments, this configuration may provide a substitute element to the reflector 440 in some respects.

FIG. 4b illustrates another antenna array provided in accordance with embodiments of the present technology. The antenna array is similar to the antenna array of FIG. 4a, except that the two antennas are separated by a greater distance, and each of the first antenna and the second antenna is provided with its own shield/reflector. Thus, an additional shield or reflector 445 is present.

In various embodiments, the radiation pattern of the first antenna is directed away from the second antenna, and the radiation pattern of the second antenna is directed away from the first antenna.

Furthermore the radiation patterns of the two antennas can be directed in opposite directions. Directing the radiation patterns in opposite directions may facilitate uniformity resulting from the combination of radiation patterns, particularly if the antennas are similar to each other. However, in other embodiments the antennas may be directed in different, non-opposite directions. The antenna directions may be chosen so that regions of high gain in one antenna compensate for regions of low gain in the other antenna. Such a configuration is appropriate for MIMO applications, for example.

In some embodiments, various antennas of the array may overlap; reside on different but parallel planes, or a combination thereof. If the array antennas are oriented such that their main lobes do not face in opposite directions, a larger antenna separation distance may be used to provide further antenna isolation.

In various embodiments, the antenna array may comprise three or more antennas. The radiation patterns of the various antennas may be configured, and the various antennas oriented, such that a desired coverage pattern is achieved. For example, the orientation of the various antennas may be adjusted to lower the peak-to-trough ratio of the array radiation pattern. Concurrently, the placement and configuration of the passive elements of the various antennas may be adjusted to lower the peak-to-trough ratio of the array radiation pattern.

In some embodiments, each array antenna is associated with a separate radiation pattern, and each array antenna is operated separately to a predetermined degree. For example, each array antenna may be coupled to its own transmitter and/or receiver. A coverage pattern then corresponds to a functional combination of these separate radiation patterns. For example, the functional combination may comprise combining channel-coded data received from separate antennas and performing error detection and correction using the combined signals, as in MIMO and diversity applications.

In some embodiments, the array antennas are operated as a phased array or unphased array, as would be readily understood by a worker skilled in the art.

In some embodiments, the array antennas are configured in combination to cover a predetermined range of angles. The antennas may be connected to separate transceivers and may concurrently transmit and receive separate signals on the same frequencies. In some embodiments, each array antenna is configured to cover a separate region of space. That is, each array antenna has a radiation pattern which exhibits relatively high gains in some regions of space and relatively low gains in other regions of space. The plural array antennas are then arranged so that the relatively high gain regions of different antennas are substantially non-overlapping. In one embodiment, the antenna array comprises two array antennas each having a radiation pattern which is concentrated on one side a theoretical dividing plane. The two array antennas are then oriented relatively so that their radiation patterns are substantially non-overlapping, and together the radiation patterns cover a region of space surrounding the antenna array. For example, the two antennas may face away from each other and work in tandem to provide 360 degrees of coverage.

In some embodiments, the array may comprise a pair of oppositely facing antennas as described above, and may additionally comprise further antennas. For example, the further antennas may have radiation patterns pointing above and/or below the plane corresponding to directions of highest gain of the first pair of antenna. For example, the first pair of antennas may radiate primarily within a first plane, and a second pair of antennas may be provided which radiate primarily in a second plane which is substantially orthogonal to the first plane.

In some embodiments, a coverage pattern corresponds to an overall antenna array radiation pattern. This may result from operating the array antennas in combination, for example by connecting plural antennas to a common transmitter and/or receiver.

In various embodiments, the arrangement of antenna elements and antennas necessary for providing a desired coverage pattern can be determined by simulation, for example using a commercially available full-wave EM simulator.

The invention will now be described with reference to specific examples. It will be understood that the following examples are intended to describe embodiments of the invention and are not intended to limit the invention in any way.

### EXAMPLES

### Example 1

FIGS. 5a and 5b illustrate front and back views of a printed circuit board comprising an antenna 500 provided in accordance with an embodiment of the present technology. The antenna comprises a pair of driven elements 510, 515, and a pair of passive elements 530, 535. The antenna may be coupled to a transmission line. Further conductive elements 540 and 545 are provided on the back side of the printed circuit board. Element 540 is a printed wire reflector. Element 545 is a free floating patch which may offer shunt capacitance for impedance matching purposes. Together with a shunt inductor which may be formed by part of the reflector 540, a distributed shunt resonator may be provided, for example to improve antenna bandwidth. The antenna 500 defines a substantially directional radiation pattern within the plane of the printed circuit board. A pair of antennas 500, oriented in opposite directions and placed proximate to each other may define an antenna array, in which the directional radiation patterns cooperatively combine to provide a substantially omnidirectional radiation pattern within the plane of the printed circuit board.

FIGS. 5c and 5d illustrate front and back views, respectively, of a printed circuit board comprising an antenna provided in accordance with an embodiment of the present technology and similar in shape to the antenna 500. The antenna is configured for operation at an operating frequency from about 1.8 GHz to about 3.6 GHz, and is dimensioned substantially as follows. W1 is 2 mm, W2 is 3.4 mm, W3 is 1.5 mm, A1 is 48 mm, A2 is 18.25 mm, A3 is 4 mm, A4 is 17.25 mm, A5 is 27.75 mm, B1 is 7.2 mm, B2 is 20 mm, D1 is 17.6 mm, R1 is 50 mm, R2 is 9 mm, and Gap is 0.5 mm.

FIG. 6 illustrates a radiation pattern 600 of an antenna array comprising a pair of prior art Yagi-Uda antennas. The graph illustrates radiation patterns 610 and 605 for first and second antennas, respectively, which are combined to form a coverage pattern 600 corresponding to the outer envelope of the radiation patterns 610 and 605. The radiation pattern is for a frequency of about 2600 MHz. An exemplary Yagi-Uda antenna 620 is also shown. The radiation pattern 600 illustrates a peak-to-trough ratio of at least about 7 dB (or 7 dBi).

FIG. 7 illustrates a graph 700 of antenna gain versus frequency for a pair of antennas in an antenna array, in accordance with an embodiment of the present technology. The graph illustrates gains 710 and 715 for first and second antennas, respectively. The antennas are as illustrated in FIGS. 5a and 5b and/or in FIGS. 5c and 5d. As illustrated, the antenna gain within the band from 2500 MHz to 2700 MHz (for example applicable to WiMAX™) applications, is maintained between about 5.2 dBi and 6.3 dBi.

FIG. 8 illustrates a radiation pattern 800 of an antenna array comprising a pair of antennas in accordance with an embodiment of the present invention, as illustrated in FIGS. 5a and 5b and/or in FIGS. 5c and 5d. The graph illustrates radiation patterns 810 and 815 for first and second antennas, respectively, which are combined to form a coverage pattern 800 corresponding to the outer envelope of the radiation patterns 810 and 815. The radiation pattern is for a frequency of about 2600 MHz. The radiation pattern 800 illustrates a peak-to-trough ratio of less than about 4.9 dB, which represents a significant improvement of at least 2 dB over the radiation pattern of FIG. 6.

In various embodiments, the antenna provides a relatively small variation in gain over an angular range of slightly more than 180 degrees, centered on a direction of highest antenna gain. This corresponds to the lowered peak-to-trough ratio described above, at least over this range. An antenna array comprising two oppositely facing such antennas may further provide for a relatively small variation in antenna array gain over a full 360 degrees, due to the combined coverage pattern of the array. In some embodiments, this is facilitated by configuring the antennas such that the deepest low-gain nulls are confined to regions which are significantly outside the above-described 180 degree angular range. For example, the deep low-gain nulls may be confined to a region which is outside a 220 degree angular range centered on a direction of highest antenna gain, a 250 degree angular range centered on a direction of highest antenna gain, a 270 degree angular range centered on a direction of highest antenna gain, or the like.

For example, FIG. 6 illustrates deep nulls located just outside a 180 degree range centered on the direction of highest antenna gain. These nulls are characteristic of Yagi style antennas and adding more directors, as is often done to boost gain in the direction of highest gain, adds more of these nulls even closer to the direction of highest antenna gain. In contrast, FIG. 8 illustrates deep nulls located outside an approximately 270 degree range centered on the direction of highest antenna gain. By pushing the antenna nulls outward from the primary direction of highest gain of the antenna, and avoiding introducing further nulls, the antenna radiation pattern in an angular region (for example 180 degrees) centered around the primary direction may be made to be more uniform.

In some embodiments, the first driven element and the second driven element are disposed substantially within a second plane, which may be substantially orthogonal to the plane which divides the first driven element from the second driven element (reference plane). In some embodiments, the first driven element and the second driven element are formed as conductive patterns on a printed circuit board surface, and the second plane coincides with the printed circuit board surface.

In some embodiments, the first passive element and the second passive element are also disposed substantially within the above-mentioned second plane.

In some embodiments, the first driven element and the second driven element are substantially symmetric about the reference plane, and the first passive element and the second passive element are substantially symmetric about the reference plane.

In some embodiments, the first passive element is disposed substantially within the second plane. In further embodiments, the second passive element is disposed substantially within a third plane parallel to the second plane. In further embodiments, the first driven element and the second driven element are substantially symmetric about the reference plane, and the first passive element and an orthogonally projected image of the second passive element onto the second plane are substantially symmetric about the plane.

In some embodiments, the first passive element is disposed substantially within a third plane parallel to the second plane, and the second passive element is disposed substantially within a fourth plane parallel to the second plane. In further embodiments, the third plane and the fourth plane are coincident. In other further embodiments, the third plane and the fourth plane are non-coincident. In yet other further embodiments, the first driven element and the second driven element are substantially symmetric about the reference plane, and an orthogonally projected image of the first passive element onto the second plane and an orthogonally projected image of the second passive element onto the second plane are substantially symmetric about the reference plane.

In some embodiments, a feedpoint of the antenna is coupled to the first driven element and the second driven element, the feedpoint crossing from the first side of the reference plane to the second side of the reference plane.

In some embodiments, a combined length of the first passive element and the second is less than a combined length of the first driven element and the second driven element.

In some embodiments, the first driven element and the second driven element are substantially symmetric about the reference plane.

In some embodiments, the first passive element is substantially parallel with the first driven element, the second passive element is substantially parallel with the second driven element, the first passive element is separated by a predetermined distance from the first driven element, and the second passive element is separated by the predetermined distance from the second driven element.

In some embodiments, the first driven element is substantially collinear with the second driven element, and the first passive element is substantially collinear with the second passive element.

In some embodiments, the first driven element is substantially collinear with the second driven element.

In some embodiments, the first passive element is substantially collinear with the second passive element.

In some embodiments, at least one of the first passive element and the second passive element are disposed at least partially out of the second plane, and an orthogonally projected image of the first passive element onto the second plane is collinear with an orthogonally projected image of the second passive element onto the second plane.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. An antenna comprising:
a. a first driven element disposed on a first side of a reference plane and a second driven element spaced apart from the first driven element and disposed on a second side of the reference plane opposite the first side;
b. a first passive element disposed within near-field distance of the first driven element, the first passive element disposed on the first side of the reference plane; and
c. a second passive element disposed within near-field distance of the second driven element, the second passive element spaced apart from the first passive element and disposed on the second side of the reference plane.

2. The antenna according to claim 1, wherein the first passive element and the second passive element are configured to provide for an antenna radiation pattern having a predetermined cross-section characterized by: a lobe extending over an arc of at least 180 degrees; and a sub-region of the lobe extending over an arc of about 180 degrees, wherein a gain variation across the sub-region is about 7 dB or less.

3. The antenna according to claim 1, wherein the first driven element and the second driven element are disposed substantially within a second plane substantially orthogonal to the reference plane.

4. The antenna according to claim 3, wherein the first driven element and the second driven element are formed as conductive patterns on a printed circuit board surface, and wherein the second plane coincides with the printed circuit board surface.

5. The antenna according to claim 1, wherein the first driven element and the second driven element are substantially symmetric about the reference plane, and wherein the first passive element and the second passive element are substantially symmetric about the reference plane.

6. The antenna according to claim 3, wherein the first passive element is disposed substantially within the second plane.

7. The antenna according to claim 3, wherein one or both of the first passive element and the second passive element is disposed substantially within a third plane parallel to the second plane.

8. The antenna according to claim 7, wherein the first driven element and the second driven element are substantially symmetric about the reference plane, and wherein an orthogonally projected image of one or both of the first passive element and the second passive element onto the second plane are substantially symmetric about the reference plane.

9. The antenna according to claim 3, wherein the first passive element is disposed substantially within a third plane parallel to the second plane, and wherein the second passive element is disposed substantially within a fourth plane parallel to the second plane.

10. The antenna according to claim 1, wherein a combined length of the first passive element and the second is less than a combined length of the first driven element and the second driven element.

11. The antenna according to claim 1, wherein the first passive element is substantially parallel with the first driven element, the second passive element is substantially parallel with the second driven element, the first passive element is separated by a predetermined distance from the first driven element, and the second passive element is separated by the predetermined distance from the second driven element.

12. The antenna according to claim 1, wherein the first driven element is substantially collinear with the second driven element.

13. The antenna according to claim 1, wherein the first passive element is substantially collinear with the second passive element.

14. The antenna according to claim 3, wherein at least one of the first passive element and the second passive element are disposed at least partially out of the second plane, and wherein an orthogonally projected image of the first passive element onto the second plane is collinear with an orthogonally projected image of the second passive element onto the second plane.

15. An antenna array comprising two or more antennas, at least one of said two or more antennas configured according to claim 1.

16. The antenna array according to claim 15, whereineach of the two or more antennas are configured to cooperatively produce a combined radiation pattern having a peak-to-trough ratio of about 7 dB or less in a predetermined plane.

17. The antenna array according to claim 16, wherein each of the two or more antennas are associated with a directional radiation pattern, and wherein the directional radiation patterns are combined to produce the combined radiation pattern.
